(19) United States
(12) Patent Application Publication
(10) Pub. No.: US 2007/0003715 A1
(43) Pub. Date: Jan. 4, 2007

(54) Ink-jet recording ink, ink-jet recording method, recording medium, and ink-jet recording device

(76) Inventors: Yoritaka Tsubaki, Nara (JP); Momomi Aoki, Nara (JP); Takanori Kamoto, Nara (JP); Hiromi Nakatsu, Hyogo (JP); Seita Suzuki, Nara (JP)

Correspondence Address: BIRCH STEWART KOLASCH & BIRCH, PO BOX 747, FALLS CHURCH, VA, 22040-0747, US

(21) Appl. No.: 10/557,725

(22) PCT Filed: May 21, 2004
(86) PCT No.: PCT/JP04/06965

§ 371 Date: Nov. 21, 2005

(30) Foreign Application Priority Data
May 21, 2003 (JP) 2003-143601

(51) Int. Cl. C09D 11/00; B41M 5/40

(52) U.S. Cl. 428/32.34; 106/31.27; 106/31.6

(57) ABSTRACT

An object of the invention is to form a recorded image having an excellent sharpness, high image density, and a prominently favorable image quality without generation of blur, offset, and the like when a high speed printing is carried out in an ink jet recording method. An ink contains colorant, water-soluble organic solvent, and water as essential components. By selecting the contents of essential components and the kind and content of a given component, an ink for ink jet recording is prepared having an initial dynamic contact angle (θ₀) of 48° or more, and a variation (Δθ/100 msec) of a dynamic contact angle for a duration of 100 msec after drop of 2.0° or more and 20.0° or less, with respect to a recording medium coated with an auxiliary fluid containing cationic resin and/or inorganic microparticles. By using the ink, an image is recorded on a plain paper coated with auxiliary fluid.

### TECHNICAL FIELD

The invention relates to an ink for ink jet recording, an ink jet recording method and a recording sheet, and an ink jet recording apparatus.

### BACKGROUND ART

In a recent ink jet recording technique, in conjunction with development of a manufacturing method of a head having a nozzle of high concentration and high definition, it has been possible to rapidly print out an image of high resolution around 2400 dpi or more by discharging minute ink droplets. Particularly, when recording is carried out on an ink jet paper provided with an ink absorbing layer on a surface of a recording medium, it is possible to obtain a recorded image of very high resolution and high image quality. However, even with the ink jet recording technique of recent date, when a color recording is carried out on a plain paper, a blur (particularly, a bead-like blur called as feathering) is generated on a border portion of adjacent ink dots, so that sharpness of the recorded image is deteriorated and at the same time, an offset is generated that the ink permeates inside without being settled on a surface layer portion of the plain paper, which deteriorates an image density of the recorded image. Accordingly, the image quality of the to-be-obtained recorded image tends to be decreased.

In view of such problems, various ink jet recording methods and inks for ink jet recording have been proposed. For instance, there has been proposed an ink jet recording method that ink discharge holes are divided into a plurality of groups so as not to discharge the ink droplets simultaneously from all the ink discharge holes, and the ink droplets are discharged at intervals from each group and moreover, nearby ink dots are recorded not at the same time, but separately whereby preventing a blur and the like (refer to, for instance, Japanese Unexamined Patent Publication JP-A 04-259566 (1992)). However, in this method, no measures for preventing the ink offset are provided. In addition, it is impossible to sufficiently avoid generation of the blur in some combinations of ink and recording medium. Further, this method has a defect that a recording speed is made extremely slow.

Moreover, there has been proposed a ink jet recording method that a sizing-coated paper is used as a recording medium, and an ink having a contact angle in 5 seconds after drop of 40° or less against the sizing-coated paper is used as an ink composition (refer to, for instance, Japanese Unexamined Patent Publication JP-A 06-092008 (1994)). However, the ink in the ink jet recording permeates a recording medium such as a plain paper for an extremely short length of time of a few milliseconds and therefore, it is not effective for prevention of generating the blur, the offset, and the like to define the contact angle in 5 seconds after the drop toward the recording medium. In practice, even by using such an ink, it is impossible to sufficiently prevent the blur, the offset, and the like.

Further, there are proposed an ink having a dynamic contact angle (advancing contact angle) against a paper of 30° or more (preferably from 30° to 60°) (refer to, for instance, Japanese Unexamined Patent Publication JP-A 06-136307 (1994)), an ink having advancing tension against a paper of 5 dyne/cm or less and a dynamic contact angle (advancing contact angle) of 10° to 80° (refer to, for instance, Japanese Unexamined Patent Publication JP-A 06-136308 (1994)), and the like. In these conventional arts, the dynamic contact angle of ink against a paper is viewed as an indicator showing permeability of ink against a paper, and the ink having the dynamic contact angle in a specific range is excellent in the permeability against a paper, which is defined as being effective for preventing the blur, the offset, and the like. However, the dynamic contact angles in these conventional arts correspond to an initial dynamic contact angle (θ₀) immediately after the ink contacts a paper, and not all such inks having the dynamic contact angles in the specific range indicate an appropriate permeability against a plain paper. This is obvious from results of examples of the present invention. For instance, according to a Table 3 shown hereinafter, it is found that the image density is deteriorated and the blur is generated when the recording is carried out on a plain paper (recording medium d) by using ink compositions (inks No. 2 to 6) having an initial dynamic contact angle (θ₀) against the plain paper (recording medium d) of 48° to 78°.

Further, there has been proposed an ink having a wet time of 0.2 seconds or shorter due to the Bristow's method, and the advancing contact angle of 40° to 70° against a plain paper having a Stockigt size degree of 10 seconds or less in 20° C. and 65% RH (refer to, for instance, Japanese Unexamined Patent Publication JP-A 10-330666 (1998)). Generally, when a visibly-sized droplet permeates a paper, a surface rough (irregularity of a surface) of the paper gives a large influence. An indicator showing a relation between permeation of the droplet into a paper, and a surface roughness of the paper is a wet time due to the Bristow's method. However, in the present ink jet recording technique, since a microliter amount of submicroscopic droplets is discharged, the permeability of the ink droplet is very rarely influenced by the surface roughness of the paper. In addition, since a wide variety of pulp materials, sizing and the like is used, even when the Stockigt size degree is within a constant range, the surface roughness in light of absorbing the ink droplets is not always uniform. Accordingly, in the ink jet recording, it is very difficult that the permeability of the ink droplets is defined only by the wet time due to the Bristow's method. At the same time, the advancing contact angle in JP-A 10-330666 also corresponds to the initial dynamic contact angle, and does not correctly indicate the permeability of the droplet as in the cases of JP-A 06-136307 and 4. Consequently, even when the ink in JP-A 10-330666 is used, it is not possible to prevent a blur on plain papers of some types.

Moreover, there has been proposed a pigment ink having a rate of time change of the dynamic contact angle on a plain paper of 0.5 to 3.5 degree/seconds (refer to, for instance, Japanese Unexamined Patent Publication JP-A 2000-144028). However, the ink in the ink jet recording permeates the plain paper for an extremely short time as described above and therefore, definition of a second-scale change rate of the dynamic contact angle is not effective for preventing the generation of a blur, an offset, and the like. In practice, according to a Table 1 shown on a page 12 of JP-A 2000-144028, it is obvious that a decrease of an optical density (image density) and generation of the feathering cannot be sufficiently prevented (examples 1 to 3 and examples 6 to 8).

Furthermore, when the ink jet recording is carried out at a high speed by using the above-described conventional ink, the defects included by an individual ink are exposed more prominently so that it is not possible to obtain a recorded image having a satisfying image quality.

At the same time, in the ink jet recording of recent date, it is demanded that the recorded image having a more enhanced image quality should be recorded by a high speed printing and especially, it is requested to more reliably prevent the generation of a blur.

### DISCLOSURE OF INVENTION

An object of the invention is to provide an ink for ink jet recording, an ink jet recording method and an ink jet recording apparatus, capable of forming a recorded image having high sharpness and image density and an extremely favorable image quality on a recording medium by a high speed printing even when the recording medium is a plain paper.

An object of the invention is to provide a recording sheet in which a recorded image of high quality having high sharpness and image density has been formed on a recording medium, especially even on plain paper.

The inventors earnestly have piled up studies in order to solve the above-mentioned problems and as a result, have found that it is possible to form a recorded image having a desired image quality regardless of the type of recording mediums by defining the permeability of an ink into a recording medium in consideration of not only an initial dynamic contact angle or a variation per millisecond time unit of a dynamic contact angle with respect to the recording medium, but also in consideration of it as a part as in the conventional ink jet recording technique, and further by applying a specific treatment to the recording medium to give a uniform ink absorbing property thereto. Thus, the invention has completed.

The invention is an ink for ink jet recording, which is an ink composition including colorant, water-soluble organic solvent, and water as essential components,

the ink for ink jet recording having an initial dynamic contact angle (θ₀) of 48° or more, preferably 50° or more, and a variation (Δθ/100 msec) of a dynamic contact angle of 2.0° to 20.0° (2.0° or more and 20.0° or less), with respect to a recording medium coated with an auxiliary fluid containing cationic resin and/or inorganic microparticles.

According to the invention, with respect to a recording medium on which a specific ink absorbing property is given by applying an auxiliary fluid containing cationic resin and/or inorganic microparticles, the ink jet recording is carried out using an ink having an initial dynamic contact angle (θ₀) and a variation of a dynamic contact angle for a duration of 100 msec after contacting the recording medium are within a specific range, whereby generation of blur, offset, and the like can be sufficiently prevented regardless of the type of the recording medium, and it is possible to form a recorded image having an excellent sharpness, high image density, and a prominently favorable image quality, so that the image quality of the recorded image remains at a high level even when a high speed printing is carried out.

Further, the invention is characterized in that water dispersible resin and/or nonionic surfactant is contained as well as colorant, water-soluble organic solvent, and water.

According to the invention, by using nonionic surfactant and/or water dispersible resin as well as colorant, water-soluble organic solvent, and water, it is made very easy to adjust the initial dynamic contact angle (θ₀) and the variation of the dynamic contact angle to fall within the above-described range.

Further, the invention is characterized in that the colorant is a pigment.

Further, the invention is characterized in that the pigment is a self-dispersing pigment.

According to the invention, a colorant contained in the ink for ink jet recording of the invention is preferably a pigment, and more preferably a self-dispersing pigment. Due to the foregoing, the generation of the blur, offset, and the like is further prevented, and the sharpness and image density and thus image quality of a to-be-obtained recorded image are further enhanced.

Further, the invention is characterized in that the cationic resin contained in the auxiliary fluid is a polyethylene imine.

According to the invention, the cationic resin contained in the auxiliary fluid for treating the recording medium is preferably polyethylene imine. Due to the foregoing, the generation of the blur, offset, and the like is further prevented, and the sharpness and image density and thus image quality of a to-be-obtained recorded image are further enhanced.

The invention is an ink jet recording method for carrying out recording by attaching an ink composition onto a recording medium, comprising attaching an auxiliary fluid containing cationic resin and/or inorganic microparticles as well as any one of inks for ink jet recording described above onto the recording medium.

According to the invention, on the recording medium exist an ink having a specific initial dynamic contact angle (θ₀) and a variation of the dynamic contact angle, and an auxiliary fluid containing cationic resin and/or inorganic microparticles, whereby blur, offset, and the like are not generated regardless of the type of the recording medium, so that it is possible to form a recorded image having excellent sharpness, high image density, and extremely favorable image quality by a high speed printing.

The invention is a recording sheet that is a recording medium on which a recorded image is formed by the above-described ink jet recording method.

According to the invention, an ink jet recording sheet is provided in which a recorded image of high quality as described above is formed on a recording medium, especially on a plain paper.

The invention is an ink jet recording apparatus comprising:

recording medium supplying means for supplying a recording medium;

recording medium conveying means for conveying the recording medium supplied by the recording medium supplying means;

printing means for carrying out recording by attaching the above-described ink for ink jet recording to the recording medium conveyed by the recording medium conveying means;

discharging means for discharging the recording medium on which a recorded image has been formed by the printing means; and

auxiliary fluid transfer means for attaching an auxiliary fluid containing cationic resin and/or inorganic microparticles to the recording medium.

Further, the invention is characterized in that the auxiliary fluid transfer means is provided so as to be included in the recording medium conveying means, or between the recording medium conveying means and the printing means.

According to the invention, an ink jet apparatus which is suitable for carrying out the above-described ink jet recording method, is provided. By using this apparatus, it is possible to form a recorded image of high quality as described above on the recording medium, especially on the plain paper by a high speed printing.

### BRIEF DESCRIPTION OF DRAWINGS

Other and further objects, features, and advantages of the invention will be more explicit from the following detailed description taken with reference to the drawing wherein:

FIG. 1 is a sectional view schematically showing a configuration of an ink jet recording apparatus of the invention; and

FIG. 2 is a view showing an evaluation standard of a blur in an image evaluation.

### BEST MODE FOR CARRYING OUT THE INVENTION

Now referring to the drawings, preferred embodiments of the invention are described below.

[Ink for Ink Jet Recording]

An ink for ink jet recording (hereinafter, simply referred to as an “ink”) of the invention has an initial dynamic contact angle (θ₀) of 48° or more, preferably 50° or more, further preferably 50° to 85° with respect to a recording medium coated with an auxiliary fluid containing cationic resin and/or inorganic microparticles, and having a variation (Δθ/100 msec) of a dynamic contact angle of 2° to 20.0°, and preferably 5° to 15°.

When the initial dynamic contact angle (θ₀) is less than 48°, a moment of the ink in a transverse direction on the recording medium is increased, and permeation in the transverse direction along a fiber constituting the recording medium is generated, and a dot becomes too large while a color density is decreased, so that it becomes hard to obtain a sharp recorded image, which is not favorable.

When the variation of the dynamic contact angle is less than 2°, there is a possibility that a dryness on the recording medium of the ink is lowered, and an ink attached to the recording medium is transferred to an item by contact with the other items, so that the recorded image formed on the recording medium is damaged. When the variation of the dynamic contact angle exceeds 20°, generation of a blur and an offset becomes prominent and further, a color mixture that inks of different colors are mixed on the recording medium is generated, so that the sharpness and image density of the recorded image are prominently decreased.

In the invention, the dynamic contact angle is measured by a DAT apparatus (manufactured by Fibro co.) under an environment of 25° C. and 60% RH. The “initial dynamic contact angle (θ₀)” is a dynamic contact angle immediately after coating of the above-described auxiliary fluid at a rate of 0.25 g/m² and drop of ink droplets of 2 μl onto a plain paper which has been dried at room temperature. Moreover, “variation (Δθ/100 msec) of the dynamic contact angle” is a summation of the dynamic contact angles measured on every 10 msec for 100 msec immediately after the coating of the above-described at 0.25 g/m² and the drop of the ink droplets of 2 μl onto the plain paper which has been dried at room temperature. This summation includes the dynamic contact angles immediately after the drop of the ink droplet and on 100 msec. Note that the contact angle is also referred to as “a liquid layer inside angle”.

The ink of the invention is a composition containing colorant, water-soluble organic solvent, and water as essential components. In other words, the ink of the invention is an ink composition which contains the colorant and the water-soluble organic solvent, and the rest of which is water.

The ink of the invention may contain water dispersible resin and/or nonionic surfactant as well as the colorant, water-soluble organic solvent, and water.

As the colorant, dye and pigment can be used.

As dye, heretofore known water-soluble dyes can be used, which include, for instance, an acidic dye, a direct dye, and a reactive dye. To give specific examples of the dye with a color index number (CI), the examples include blue dyes such as acid blue 7, 9, 29, 45, 92 and 249, direct blue 1, 2, 6, 15, 22, 25, 71, 76, 79, 86, 90, 98, 163, 165, 199 and 202, and reactive blue 1, 2, 7, 14, 15, 23, 32, 38, 41, 63, 80 and 95; red dyes such as acid red 1, 8, 13, 14, 18, 26, 27, 35, 37, 42, 52, 82, 87, 89, 92, 97, 106, 111, 114, 115, 134, 186, 249, 254 and 289, direct red 1, 4, 9, 13, 17, 20, 28, 31, 39, 80, 81, 83, 89, 225 and 227, direct orange 26, 29, 62 and 102, and reactive red 1, 14, 17, 25, 26, 32, 37, 44, 46, 55, 60, 66, 74, 79, 96, 97, 141, 147 and 181; yellow dyes such as acid yellow 1, 7, 17, 23, 42, 44, 79 and 142, direct yellow 1, 12, 24, 26, 33, 44, 50, 86, 120, 132, 142 and 144, and reactive yellow 1, 5, 11, 13, 14, 20, 21, 22, 25, 40, 47, 51, 55, 65 and 67; and black dyes such as food black 2, direct black 19, 22, 32, 38, 51, 56, 71, 74, 75, 77, 154, 168 and 171, and reactive black 3, 4, 7, 11, 12 and 17. It is preferred, among these, to employ a dye excellent in water resistance, lightfastness, safety to a human body, and the like. These dyes may be used alone, or two or more dyes may be appropriately used in a combination. A content of the dye is not particularly limited and may be appropriately selected from a wide range in accordance with various conditions such as a kind of the dye itself, composition of the auxiliary fluid coated on the recording medium, a component other than the dye, which is contained in an ink, and a content of the component. However, in view of dissolution stability of the dye in the ink at room temperature, an image density of the to-be-obtained recorded image, and the like, the content of the dye is generally 0.1 to 10 wt. %, and preferably 0.1 to 8 wt. % of the total ink.

As pigment, heretofore known inorganic pigments and organic pigments can be used. The inorganic pigments include, for instance, titanium oxide and iron oxide, and carbon black manufactured by heretofore know methods such as a contact method, a furnace method, and a thermal method. To give specific examples of the organic pigments with a color index number (CI), the examples include, for instance, blue pigments such as pigment blue 1, 2, 15, 15:1, 15:2, 15:3, 15:4, 15:6, 16, 17, 22, 21, 22, 60 and 64; red pigments such as pigment red 1, 2, 3, 5, 10, 16, 23, 30, 31, 48:1, 48:2, 49:1, 52, 53:1, 57:1, 58:4, 63, 122 and 209, and pigment violet 19; and yellow pigments such as pigment yellow 3, 12, 13, 14, 15, 23, 55, 74, 83, 93, 95, 97, 128, 138, 150, 154, 167, 180 and 193. It is preferred, among these, to employ a pigment having high safety to a human body.

Further, in the invention, a self-dispersing pigment having a favorable affinity with water may be employed. The self-dispersing pigment can be manufactured by applying chemical treatment and/or physical treatment to the pigment, and reforming a pigment surface to hydrophilia. For the chemical treatment, heretofore know methods can be employed, which include, for instance, acid treatment (for instance, a method of direct treatment by fuming sulfuric acid and chlorosulfonic acid in a wet process in the atmosphere), a treatment due to a coupling agent such as a silane compound, and a treatment for grafting a hydrophilic polymer on the pigment surface. For the physical treatment, heretofore known methods can be also employed, which include, for instance, an exposure in reactive plasma gas (to be specific, a method of exposure in glow discharge plasma of low-pressure oxygen gas under vacuum), a method of adding a high speed shear to a mixture of the pigment and organic solvent by a high speed mixer or the like. Note that it is important to optimize treatment conditions and at the same time, to select a pigment having a resistance to a surface treatment since there is a pigment on the surface, which is subject to dissolution and discoloration at the time of the treatment.

The pigment may be used alone, or two or more pigments may be used in a combination.

A content of the pigment is not particularly limited and may be appropriately selected from a wide range in accordance with various conditions such as a kind of the pigment itself, composition of the auxiliary fluid coated on the recording medium, a component other than the pigment, which is contained in an ink, and a content of the component. However, in view of a decrease of a discharge stability of the ink due to an increase in viscosity, an image density of the to-be-obtained recording image and the like, the content of the pigment is generally 0.1 to 10 wt. %, and preferably 0.1 to 8 wt. % of the total ink.

Among such colorants, in view of the sharpness of the to-be-obtained recorded image, the pigment is preferable, and the pigment (self-dispersing pigment) which has been given the surface treatment and to a surface of which the hydrophilia is applied, is particularly preferable.

The water-soluble organic solvent is used, for instance, for enhancing permeability and coating property with respect to the recording medium of the ink. As the water-soluble organic solvent, heretofore known solvents can be used, which include, for instance, amide such as dimethylformamide and dimethylacetamide; glycol such as polyethylene glycol, polypropylene glycol, ethylene glycol, diethylene glycol, thiodiglycol, propylene glycol, triethylene glycol, 1,5-pentanediol, 1,4-butanediol, 1,2-hexanediol, and 1,3-propanediol; trivalent or more polyhydric alcohol such as glycerin and 1,2,6-hexanetriol; glycol ether such as ethylene glycol monomethyl ether, ethylene glycol monobutyl ether, diethylene glycol monomethyl ether, diethylene glycol monoethyl ether, triethylene glycol monobutyl ether, propylene glycol monoethyl ether, tetraethylene glycol monomethyl ether, and ethylene glycol monophenyl ether; sulfur-containing compounds such as sulforane or dimethyl sulfoxide; nitrogen-containing heterocycle compounds such as 2-pyrrolidone, N-methylpyrrolidone and ε-caprolactam, oxygen-containing heterocycle compounds such as γ-butyrolactone; and polyfunctional compounds such as dimethylamino ethanol, diethylamino ethanol, triethanolamine and morpholine.

Among these water-soluble organic solvents, glycol such as diethylene glycol, 1,2-hexanediol, 1,5-pentanediol, and polypropylene glycol; trivalent or more polyhydric alcohol such as glycerin; and glycol ether such as triethylene glycol monobutyl ether, and tetraethylene glycol monomethyl ether can be preferably used. The water-soluble organic solvent may be used alone, or two or more water-soluble organic solvents may be appropriately used in a combination. A content of the water-soluble organic solvent is not particularly limited and may be appropriately selected from a wide range in accordance with various conditions such as a kind of the water-soluble organic solvent itself, composition of the auxiliary fluid coated on the recording medium, a component other than the water-soluble organic solvent, which is contained in an ink, and a content of the component. However, in view of applying appropriate permeability and dryness with respect to the recording medium, the content of the water-soluble organic solvent is generally 10 to 70 wt. %, and preferably 10 to 50 wt. % of the total ink. Note that in a case of aiming to obtain an auxiliary fluid containing more water than the water-soluble organic solvent, a content of the water-soluble organic solvent is 10 to 40 wt. %, and preferably 10 to 30 wt. % of the total auxiliary fluid.

The water dispersible resin is used, for instance, for enhancing a fixing property of the colorant onto the recording medium. As the water dispersible resin, heretofore known resin can be used, which include, for instance, polyester resin, acrylic resin, styrene-acrylic copolymer, maleic acid resin, polyurethane resin, and the like which can be dispersed in water. Water dispersible resin on the market can be used, which include, for instance, Micro Gel (trade name: water dispersible styrene-acrylic resin) manufactured by Nippon Paint Co., Voncoat (trade name: water dispersible styrene-acrylic resin) manufactured by Dainippon Ink and Chemicals Co., Vylonal (trade name: water dispersible polyester resin) manufactured by Toyobo Co., and Joncryl (trade name: emulsion type) manufactured by Johnson Polymer Co. Among these products, the water dispersible polyester resin, the water dispersible acrylic resin, and the like are preferable. The water dispersible resin may be used alone, or two or more water dispersible resin may be used in a combination as appropriate. A content of the water dispersible resin is not particularly limited and may be appropriately selected from a wide range in accordance with various conditions such as a kind of the water dispersible resin itself, composition of the auxiliary fluid coated on the recording medium, a component other than the water dispersible resin, which is contained in an ink, and a content of the component. However, in order that an additive effect of the water dispersible resin is sufficiently exhibited and that the discharge stability and preservation stability (which means that aggregation and deposition of the ink component do not occur at the time of preservation) are not damaged, the content of the water dispersible resin is generally 0.01 to 30 wt. %, and preferably 0.1 to 20 wt. % of the total ink.

The nonionic surfactant is used, for instance, for purposes such as a further enhancement of the permeability with respect to the recording medium of the ink. As the nonionic surfactant, heretofore known agents can be used. Among these agents, for instance, an ethylene oxide containing nonionic surfactant is preferable, such as an acetylene glycol-ethylene oxide adduct (in the description, also referred to as an ethylene oxide containing acetylene nonionic surfactant) shown by a general formula (1): 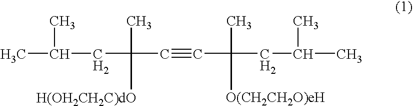
(wherein d and e respectively indicate integers of 0 or 0 to 30 which satisfy a relation of 0≦d+e≦30), an ethylene oxide compound shown by a general formula (2): 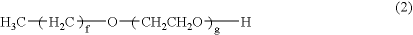
(wherein f indicates an integer of 11 to 13, and g indicates an integer of 3 to 30),
an ethylene oxide compound shown by a general formula (3): 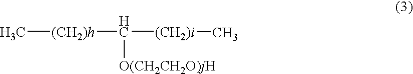
(wherein h and i respectively indicate integers of 0 to 11, and j indicates an integer of 3 to 50),
an ethylene oxide-propylene oxide compound shown by a general formula (4): 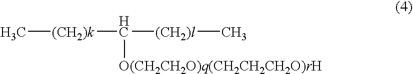
(wherein q indicates an integer of 5 to 9, r indicates an integer of 2 to 5, and k and l respectively indicate integers of 0 to 11 which satisfy a relation of 9≦k+1≦11),
and an ethylene oxide-propylene oxide compound shown by a general formula (5):
HO(CH₂CH₂O)ₛ(CH₂CH₂CH₂O)ₜ(CH₂CH₂O)ᵤH (5)
(wherein s indicates an integer of 0 to 18, t indicates an integer of 2 to 15, and u indicates an integer of 0 to 18).

A nonionic surfactant which is particularly preferable is the acetylene glycol-ethylene oxide adduct shown by the general formula (1).

In the invention, nonionic surfactants on the market can be used, which include, for instance, Surfynol (trade name: manufactured by Air Products Co.), Softanol EP (trade name: manufactured by Nippon Shokubai Co., and the like. Note that the Surfynol is also marketed from Nissin Chemical Industry Co. The nonionic surfactant may be used alone, or two or more nonionic surfactants may be used in a combination. A content of the nonionic surfactant is not particularly limited and may be appropriately selected from a wide range in accordance with various conditions such as a kind of the nonionic surfactant itself, composition of the auxiliary fluid coated on the recording medium, a component other than the nonionic surfactant, which is contained in an ink, and a content of the component, but the content of the nonionic surfactant is generally 0.001 to 5 wt. %, and preferably 0.001 to 3 wt. % of the total ink.

Further, the ink of the invention may contain one or two components selected from water-soluble resin, permeating agent, wetting agent, pH adjuster, solvent having excellent balance of hydrophilicity-lipophilicity, low-boiling organic solvent, and the like.

The water-soluble resin is used, for instance, for purposes such as color formation at high saturation of the colorant and prevention of detachment of the colorant when the recording medium having the colorant fixed thereon is scrubbed and passes by the other recording medium or the like (enhancement of scrub resistance). Further, in a case where the colorant is an organic pigment which does not have a sufficient hydrophilia, the colorant functions also as a dispersant of the organic pigment. As the water-soluble resin, heretofore known resin which is effective for the color formation at high saturation of the pigment, the enhancement of the scrub resistance, or the like, can be used. The heretofore known resin include, for instance, hydrophilic resin of acid number 50 to 300 (preferably 25 to 80) having a carboxyl group, and hydrophilic polymer having 2000 to 20000 (preferably 2500 to 15000) of weight-average molecular weight which contains styrene units and/or α-methylstyrene units of 35% or more. To be more specific, there are included a styrene-acrylic acid copolymer, styrene-α-methylstyrene-acrylic acid copolymer, styrene-acrylic acid-acrylic acid ester (preferably acrylic acid alkyl ester having a carbon number 1 to 4 in the alkyl part) copolymer, styrene-methacrylic acid-acrylic acid ester (preferably acrylic acid alkyl ester having a carbon number 1 to 4 in the alkyl part) copolymer, polyvinyl alcohol, and polyvinyl pyrrolidone. Moreover, as the water-soluble resin, water-soluble resin of regulated polymerized type can be used. The water-soluble resin of regulated polymerized type indicates water-soluble resin which contains on an end or middle of a molecule a functional group being capable of hydrogen binding to and covalently binding to a functional group of the pigment and which contains a hydrophilic group on the end of the molecule, with a structure having regularly arranged constitutional units such as an alternating copolymer and a block copolymer. Specific examples of the water-soluble resin of regulated polymerized type include, for instance, Solsperse S20000, S27000, S12000, S22000, S24000GR, S26000, S28000, S13240, and S5000 (all trade names: manufactured by Zeneca Co.). The water-soluble resin may be used alone, or two or more water-soluble resin may be appropriately used in a combination. A content of the water-soluble resin is not particularly limited and may be appropriately selected from a wide range. However, in view of sufficient exhibition of the effect for enhancing the scrub resistance and the prevention of aggregation and deposition of the ink component due to a increase in viscosity, the content of the water-soluble resin is generally 1 to 15 wt. %, and preferably 2 to 8 wt. % of the total ink.

The permeating agent has an action for decreasing surface tension of the ink, and accelerates drying of the ink on the recording medium, and uniformly disperses and fixes the colorant, particularly the pigment, on the recording medium. In addition, the permeating agent shows an effect that a blur of the ink is prevented from being generated in a case where the recording medium is a plain paper. As the permeating agent, heretofore know compounds having the action for decreasing the surface tension of the ink can be used. The heretofore know compounds include, for instance, glycol ether such as ethylene glycol-n-butyl ether, diethylene glycol-n-butyl ether, triethylene glycol-n-butyl ether, propylene glycol-n-butyl ether, and dipropylene glycol-n-butyl ether; anionic fluorochemical surfactant such as perfluoroalkyl sulfonate (for instance, ammonium salt and potassium salt) and perfluoroalkyl carboxylate (for instance, potassium salt); and nonionic fluorochemical surfactant such as perfluoroalkyl polyoxyethylene ethanol, perfluoroalkyl alkoxylate, and fluorinated alkyl ester. Note that a part of the glycol ether illustrated here partly overlaps the glycol ether of the water-soluble organic solvent. The overlapped glycol ether can be used in both of the water-soluble organic solvent and the permeating agent. The permeating agent may be used alone, or two or more permeating agents may be appropriately used in a combination. A content of the permeating agent is not particularly limited and may be appropriately selected from a wide range. However, in view of acceleration of drying the ink on the recording medium and sufficient exhibition of the blur preventing effect, the content of the permeating agent is generally 0.1 to 5 wt. %, and preferably 0.5 to 4 wt. % of the total ink.

The wetting agent is used for purposes such as prevention of aggregation and deposition of the ink component, especially the colorant in preserved ink (enhancement of the preservation stability), further enhancement of the fixing property of the colorant onto the recording medium, and prevention of clogging in a discharge nozzle due to drying of the ink. The wetting agents include, for instance, diethylene glycol, polyethylene glycol, polypropylene glycol, tetrapropylene glycol, pentaethylene glycol, hexaethylene glycol, heptaethylene glycol, octaethylene glycol, ethylene glycol, propylene glycol, butylene glycol, triethylene glycol, 1,2,6-hexanetriol, thioglycol, hexylene glycol, trimethylolethane, and trimethylolpropane. A part of the wetting agent illustrated here overlaps the glycol and polyhydric alcohol of the water-soluble organic solvent. The overlapped wetting agent can be used in both of the water-soluble organic solvent and the wetting agent. A content of the wetting agent is not particularly limited and may be appropriately selected from a wide range. However, the content of the wetting agent is generally 0.5 to 40 wt. % of the total ink.

The pH adjuster is used for purposes such as prevention of clogging in a discharge nozzle or the like due to drying of the ink. The pH adjusters include, for instance, nitrogen-containing compounds such as urea, 2-pyrolidone, N-methyl-2-pyrolidone, 1,3-dimethyl-imidazolidinone, diethanolamine, and triethanolamine. A part of the pH adjuster illustrated here overlaps the water-soluble organic solvent. The overlapped pH adjuster can be used for both of the water-soluble organic solvent and the pH adjuster. A content of the pH adjuster is not particularly limited and may be appropriately selected from a wide range. However, the content of the pH adjuster is generally 1 to 10 wt. % of the total ink.

As the solvent having excellent balance of hydrophilicity-lipophilicity, the solvents include, for instance, diglycerin and polyglycerin besides the glycerin illustrated as the water-soluble organic solvent. Such a solvent can be used alone, or two or more solvents can be used in a combination. A content of the solvent is not particularly limited and may be appropriately selected from a wide range. However, the content of the solvent is generally 2 to 20 wt. % of the total ink.

As the low-boiling organic solvent, heretofore known solvents can be used. Among such solvents, monohydroxy alcohol is preferable. The monohydroxy alcohol includes, for instance, primary, secondary, and tertiary alcohols such as methanol, ethanol, n-propanol, iso-propanol, n-butanol, sec-butanol, tert-butanol, iso-butanol, and n-pentanol. The low-boiling organic solvent can be used alone, or two or more low-boiling organic solvents can be used in a combination. A content of the low-boiling organic solvent is not particularly limited and may be appropriately selected from a wide range. However, the content of the low-boiling organic solvent is generally 0.5 to 10 wt. %, and preferably 1.5 to 6 wt. % of the total ink.

Furthermore, to the ink of the invention, an appropriate physicality adjuster can be added according to need in order to improve various physicalities of the ink. The physicality adjusters include, for instance, viscosity adjuster, fungicide, and antiseptics.

The ink of the invention can be prepared by using appropriate amounts of the colorant and water-soluble organic solvent, and according to need, an appropriate amount of each of the water-soluble resin, permeating agent, wetting agent, pH adjuster, solvent having excellent balance of hydrophilicity-lipophilicity, low-boiling organic solvent, and other physicality adjuster, and in addition, using water to make the total amount up to 100 wt. %, so as to dissolve or disperse these components in the water and further, as appropriate, by filtration under normal pressure, reduced pressure, or increased pressure.

The dissolution and dispersion are carries out by use of a normal distributor. The distributors include, for instance, a disper, a sand mill, a homogenizer, a ball mill, a bead mill, a paint shaper, and an ultrasonic distributor. Moreover, a mixer equipped with blades for mixing, a high speed distributor, an emulsion machine, and the like may be used.

For the filtration, for instance, a filter having a hole diameter of 0.8 μm or smaller, a filter having a hole diameter of 0.45 μm or smaller, or the like is used.

In the invention, types and contents of the colorant and water-soluble organic solvent which are essential components are appropriately selected, and further according to need, a given component is appropriately selected to be added to the ink of the invention and thereby, the initial dynamic contact angle and variation of the dynamic contact angle can be adjusted to predetermined values.

Among the given components, particularly by adding the nonionic surfactant and/or water dispersible resin and then appropriately selecting contents thereof preferably from each of the above-described content ranges, it is made easier to adjust the values of the initial dynamic contact angle and dynamic contact angle.

To be specific, for instance, by respectively using the pigment or self-dispersing pigment as the colorant; the glycol (preferably two or more glycol) and polyhydric alcohol, or glycol, polyhydric alcohol, and glycol ether as the water-soluble organic solvent; the nonionic surfactant; and as appropriate, the water dispersible resin, and by using generally 100 to 700 parts by weight, and preferably 120 to 450 parts by weight, and more preferably 150 to 400 of other water-soluble organic solvents as total amount thereof with respect to 100 parts by weight of the polyhydric alcohol, and then by dispersing these components in water, it is possible to obtain the ink of the invention having predetermined initial dynamic contact angle and variation of the dynamic contact angle.

In order to measure the initial dynamic contact angle and variation of the dynamic contact angle of the ink of the invention, the auxiliary fluid coated on the recording medium is a composition containing cationic resin and/or inorganic microparticles and water.

As the cationic resin, heretofore known resin having a cationic group can be used. The heretofore known resin include, for instance, polyethylene imine, polyvinyl amine, polyvinyl pyrrolidone, and derivatives thereof. A molecular weight of the cationic resin is not particularly limited. However, cationic resin having around 20000 to 2000000 of weight-average molecular weight is preferable. The cationic resin may be used alone, or two or more cationic resin may be used in a combination. A content of the cationic resin is not particularly limited and may be appropriately selected from a wide range in accordance with various conditions such as a kind of the cationic resin itself, a component other than the cationic resin, which is contained in the auxiliary fluid, a content of the component, composition of the ink of the invention, and a material of the recording medium. However, in view of operability of embrocation and usability of a paper after coating, and the like, the content of the cationic resin is generally 0.1 to 20 wt. %, and preferably 5 to 12 wt. % of the total auxiliary fluid.

As the inorganic microparticles, heretofore known powdery inorganic compounds can be used, which include, for instance, silica, alumina, alumina hydrate, titania, zirconia, boria, silica-boria, ceria, magnesia, silica-magnesia, calcium carbonate, magnesium carbonate, zinc oxide, hydrotalcite, and inorganic microparticles into which these components are cationized. A particle diameter of the inorganic microparticle is not particularly limited, but it is preferable to use an inorganic microparticle having a particle diameter of around 2 to 10 μm. The inorganic microparticles may be used alone, or two or more inorganic microparticles may be in a combination. A content of the inorganic microparticles is not particularly limited and may be appropriately selected from a wide range in accordance with various conditions such as a kind of the inorganic microparticle itself, a component other than the inorganic microparticle, which is contained in the auxiliary fluid, a content of the component, composition of the ink of the invention, and a material of the recording medium. However, in view of color formation of the colorant regardless of the type of the recording medium, preservation stability of the auxiliary fluid, discharge stability in a case where the auxiliary fluid is discharged from a liquid discharge nozzle to the recording medium, and the like, the content of the inorganic microparticle is generally 0.1 to 40 wt. %, and preferably 1 to 30 wt. %, and more preferably 3 to 15 wt. % of the total auxiliary fluid.

The auxiliary fluid may contain salt. The salt is used for purposes such as pH stability of the auxiliary fluid. As the salt, heretofore known water-soluble salts which are dissolved in water and ionized can be used. The heretofore known water-soluble salts include, for instance, chloride such as alkaline metal, alkaline-earth metal, and aluminum, carbonate, acetate, sulfate, nitrate, sulfite, and nitrite. Specific examples thereof include, for instance, chloride such as sodium chloride, potassium chloride, lithium chloride, ammonium chloride, calcium chloride, magnesium chloride, and barium chloride; carbonate such as calcium carbonate, magnesium carbonate, barium carbonate, sodium carbonate, lithium carbonate, and ammonium carbonate; acetate such as sodium acetate, potassium acetate, and lithium acetate; sulfate such as sodium sulfate, potassium sulfate, and aluminum sulfate. The salt may be used alone, or two or more salts may be used in a combination. A content of the salt is not particularly limited and may be appropriately selected from a wide range in accordance with various conditions such as a kind of the salt itself, a component other than the salt, which is contained in the auxiliary fluid, a content of the component, composition of the ink of the invention, and a material of the recording medium. However, the content of the salt is generally 0.1 to 20 wt. %, and preferably 1 to 10 wt. % of the total auxiliary fluid. Moreover, a buffer fluid containing salt can be used. A content of the buffer fluid is not particularly limited and may be appropriately selected in accordance with a type of the buffer fluid so that a desired effect can be obtained.

The auxiliary fluid may contain a surfactant. The surfactant is used for purposes such as enhancement of permeability and fixing property of the auxiliary fluid to the recording medium and further enhancement of image quality of the recorded image on the recording medium coated with the auxiliary fluid. As the surfactant, a surfactant having high permeability to a paper is preferable. The surfactants include, for instance, anionic surfactants such as fatty acid salt, fatty alcohol sulfate, liquid fatty oil sulfate ester salt, and alkyl allyl sulfonic acid salt; and nonionic surfactants such as poly oxyethylene alkyl ether, poly oxyethylene alkyl ester, poly oxyethylene sorbitan alkyl ester, acetylene alcohol, and acetylene glycol. Such a surfactant may be alone, or two or more surfactants may be used in a combination. A content of the surfactant is not particularly limited and may be appropriately selected from a wide range in accordance with various conditions such as a kind of the surfactant itself, a component other than the surfactant, which is contained in the auxiliary fluid, a content of the component, composition of the ink of the invention, and a material of the recording medium. However, the content of the surfactant is generally 0.02 to 1.0 wt. %, and preferably 0.05 to 0.5 wt. % of the total auxiliary fluid.

The auxiliary fluid may further contain glycol, primary alcohol, water dispersible resin, and the like. These components of the same kinds which were cited as the components of the ink of the invention can be used. Contents of the glycol and/or primary alcohol are not particularly limited, but generally 5 to 20 wt. % of the total auxiliary fluid. A content of the water dispersible resin is also not particularly limited, but generally 3 to 10 wt. % of the total auxiliary fluid in solid amount.

The auxiliary fluid can be generally obtained by using appropriate amounts of the cationic resin and/or inorganic microparticles, and according to need, an appropriate amount of each of the salt, surfactant, glycol, primary alcohol, and water dispersible resin, and in addition, using water to make the total amount with the above components up to 100 wt. %, so as to disperse and/or dissolve the above components in the water and thereby, dispersing and/or dissolving the above components in the water for about one hour. For the dispersion and dissolution, an apparatus used for dispersing or dissolving the ink of the invention can be used.

The recording medium to be coated with the auxiliary fluid is not particularly limited, and a recording medium which has been conventionally applied to the ink jet recording can be used. Specific examples of the recording medium include, for instance, commonly used recording mediums containing a row material for pulp such as a plain paper, a coated paper (color copying paper, ink-jet printing paper, etc.), and a gross paper.

When coating the recording medium with the auxiliary fluid, it is possible to employ heretofore known methods of coating a solid material with a fluid material. The methods include a brush painting, a roll coater method, a blade coater method, an air-knife coater method, a bar coater method, a size press method, a spray coating method, a gravure coater method, and a curtain coater method. The auxiliary fluid may be discharged from the same discharge nozzle as the ink discharge nozzle to the recording medium. Furthermore, the recording medium may be dipped in the auxiliary fluid, and impregnated with the auxiliary fluid. A coating amount of the auxiliary fluid onto the recording medium is not particularly limited and may be appropriately selected from a wide range in accordance with composition of the auxiliary fluid, a material of the recording medium, composition of the ink, and the like. However, in view of image quality, sharpness, image density, and the like of the recorded image formed on the recording medium on which the auxiliary fluid has been coated, the coating amount of the auxiliary fluid is generally 1.0 to 4.0 g/m², and more preferably 1.5 to 3.0 g/m² in solid amount.

[Ink Jet Recording Method]

The invention is characterized in that an ink jet recording method is a method of conducting a recording by attaching an ink composition onto a recording medium by an inkjet system wherein an auxiliary fluid containing cationic resin and/or inorganic microparticles together with an ink for ink jet recording of the invention is attached onto the recording medium.

As the ink composition, the above-described ink for ink jet recording of the invention having the initial dynamic contact angle and the variation of dynamic contact angle in a specific range is used. The attachment of the ink onto the recording medium is carried out by discharging the ink onto the recording medium in accordance with the heretofore know inkjet system. The inkjet system is not particularly limited and the heretofore known systems can be employed. The heretofore known systems include, for instance, an inkjet system in which a piezoelectric element is used (piezo system), an inkjet system in which the ink is given pressure so that droplets of the ink are discharged, and an inkjet system in which air bubbles are generated by using a film boiling phenomenon so that the ink is discharged (thermal system). Among these systems, the piezo system, the thermal system, or the like is preferable.

As the auxiliary fluid to be attached onto the recording medium, there is used the above-described auxiliary fluid which contains the cationic resin and/or inorganic microparticles and may further contain salt, surfactant, glycol, primary alcohol, water dispersible resin, and the like. The attachment of the auxiliary fluid onto the recording medium is carried out by coating the recording medium with the auxiliary fluid, or by offering a part of the ink discharge nozzles of the ink jet recording apparatus to the auxiliary fluid discharge nozzle so that the auxiliary fluid is discharged from the auxiliary fluid discharge nozzle to the recording medium. For coating methods of the auxiliary fluid onto the recording medium, general methods of coating a solid material with a fluid material can be employed, which include a roll coater, an air-knife coater, a blade coater, a brush coating, and the like. In addition, a spray coating, a dipping coating, and the like can be carried out. The attachment of the auxiliary fluid onto the recording medium is carried out at the same time, before, or after the ink is attached onto the recording medium. However the attachment is preferably carried out before or at the same time that the ink is attached onto the recording medium, and more preferably before the ink is attached onto the recording medium.

A using proportion of the ink and the auxiliary fluid is not particularly limited and may be appropriately selected from a wide range in accordance with various conditions such as, in each composition (kind and content of each component), a kind (such as material) of the recording medium onto which these components are attached, a to-be-printed dimension of the recording medium, a type of the inkjet systems, a droplet amount of the ink, and a droplet amount of the auxiliary fluid. However, to provide one indication, for instance in a case where the droplet amount of the ink is around 1 to 50 pl, the auxiliary fluid of 1 to 10⁷ parts by weight, preferably 10 to 10⁷ parts by weight can be generally used with respect to the ink of 100 parts by weight.

As the recording medium, it is possible to use recording mediums which have been conventionally used for ink jet recording. The recording mediums include, for instance, commonly used paper-type recording mediums including pulp materials such as a plain paper, a coated paper (color copying paper, ink-jet printing paper, etc.), a gross paper, and a postcard; a plastic sheet; and a plastic film. Among these recording mediums, the paper-type recording mediums are preferable.

[Ink Jet Recording Apparatus]

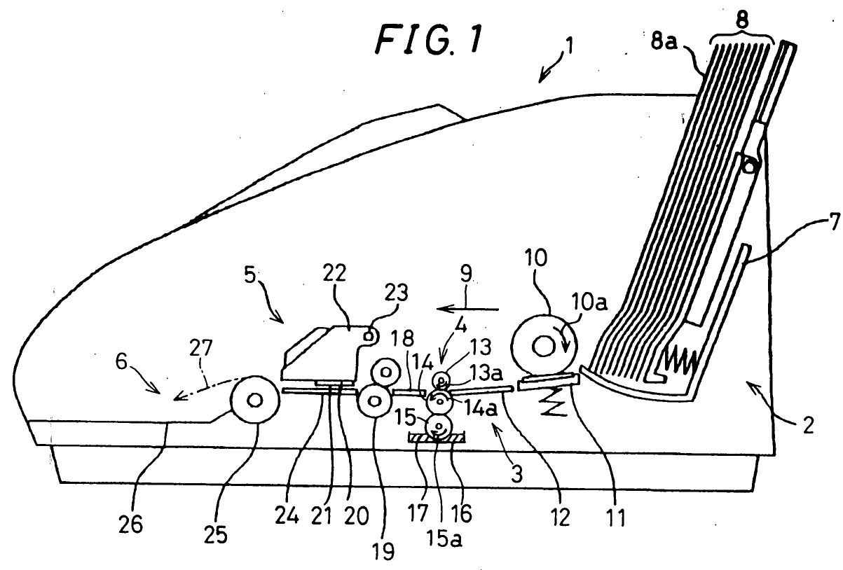

FIG. 1 is a sectional view schematically showing a configuration of an ink jet recording apparatus 1 according to a first embodiment. The ink jet recording apparatus 1 comprises: recording medium supplying means 2 for supplying a recording medium 8 into the apparatus 1; recording medium conveying means 3 for conveying the recording medium 8 supplied into the apparatus 1 by the recording medium supplying means 2; auxiliary fluid transfer means 4 provided so as to be included in the recording medium conveying means 3, for attaching an auxiliary fluid to the recording medium 8; printing means 5 for recording an image by attaching ink composition containing a color material to the recording medium 8 which has been conveyed by the recording medium conveying means 3 and to which the auxiliary fluid has been attached by the auxiliary fluid transfer means 4; and discharging means 6 for discharging to outside of the apparatus 1 the recorded image 8 on which a recorded image has been formed by the printing means 5. These are disposed in this order from an upstream side to a downstream side in a conveying direction of the recording medium 8 shown by an arrow 9 in FIG. 1.

The recording medium feed means 2 comprises a paper feed tray 7 for containing the recording medium 8, a feed roller 10 disposed on a downstream side of the feed tray 7, and a separation plate 11.

The recording medium conveying means 3 comprises two guide plates 12 and 18, and a pair of conveying rollers 19 disposed on a downstream side of the guide plate 18. Between the guide plate 12 and the guide plate 18 is provided the auxiliary fluid transfer means 4.

The auxiliary fluid transfer means 4 comprises a support roller 13, a transfer roller 14, a gravure roller 15, and an ink pan 16 which is filled up with an auxiliary fluid 17 so that a gravure face of the gravure roller 15 is dipped into the auxiliary fluid 17. The support roller 13 and the transfer roller 14 have faces contacted with each other, but are disposed so that the recording medium 8 can pass therebetween. Further, the transfer roller 14 and the gravure roller 15 are disposed so as to contact with each other.

The printing means 5 comprises: an ink head 20 for discharging and attaching the ink composition to the recording medium 8; an ink carriage 22 integrated into a single body with the ink head 20, for moving the ink head 20 with respect to a print face 8a of the recording medium 8; a guide shaft 23 for supporting the ink carriage 22 slidably in a vertical direction with respect to a drawing; and a platen 24 for mounting the recording medium 8 thereon.

The discharging means 6 comprises a discharge roller 25 and a discharge tray 26.

An operation of the ink jet recording apparatus 1 according to the invention will be described hereinbelow.

According to the ink jet recording apparatus 1, the recording medium 8 contained in the paper feed tray 7 is separated sheet by sheet and supplied to the recording medium conveying means 3, and then conveyed to the auxiliary fluid transfer means 4 via the guide plate 12 by the feed roller 10 which rotates in an arrow 10a direction in accordance with a timing signal, and the separation plate 11.

In the auxiliary fluid transfer means 4, when the gravure roller 15 rotates in an arrow 15a direction by driving means (not shown), the auxiliary fluid 17 with which the ink pan 16 is filled permeates a gravure face of the gravure roller 15 and further is attached to a surface of the transfer roller 14. The auxiliary fluid 17 attached to the surface of the transfer roller 14 contacts the recording medium 8 which is conveyed by passing between the support roller 13 and the transfer roller 14, and is transferred to a reverse face of the print face 8a of the recording medium 8, by rotation in an arrow 14a of the transfer roller 14 driven by rotation of the gravure roller 15. At this time, the recording medium 8 is pushed by the support roller 13 and the transfer roller 14 and therefore, the auxiliary fluid 17 reliably permeates the print face 8a of the recording medium.

The recording medium 8 thus coated with the auxiliary fluid is supplied to the conveying roller 19 via the guide plate 18, and further conveyed to the print portion 5 by the conveying roller 19 and then mounted on the platen 24 with the print face 8a up. At this time, the ink composition is discharged from the ink head 20 and attached to the print face 8a of the recording medium 8 so that the recorded image is formed. The recording medium 8 on which the recorded image has been formed is discharged in an arrow 27 direction via the discharge roller 26, and contained in the discharge tray 26.

In the embodiment, the auxiliary fluid transfer means 4 is provided so as to be included in the recording medium conveying means 3. However, the auxiliary fluid transfer means 4 is not limited to this configuration, but may be provided between the conveying roller 19 and the printing means 5.

Further, in the embodiment, between the auxiliary fluid transfer means 4 and the conveying roller 19, or between the conveying roller 19 and the printing means 5 may be provided reverse means of the recording medium 8, for reversing the recording medium 8 so that the ink composition is discharged to a face coated with the auxiliary fluid. Such reverse means may follow heretofore known methods.

Further, in another embodiment of the ink jet recording apparatus, in the commonly used ink jet recording apparatus, a part of a plurality of the ink discharge nozzles may be modified so as to discharge the auxiliary fluid. Furthermore, the ink jet recording apparatus may be modified so that a new auxiliary fluid nozzle is disposed besides the ink discharge nozzles.

### EXAMPLES

Examples and comparative examples will be cited, and the invention will be specifically described.

### Example 1 and Comparative Example 1 (Adjustment of the Ink)

An ink composition was prepared by mixing each component in a proportion (wt. %) shown in Table 1. Among inks of No. 1 to 6, inks of No. 2 to 6 are inks of the example 1 and an ink of No. 1 is an ink of the comparative example 1.

Note that in the Table 1, the surfactant and the water dispersible resin which are stated by trade names are specifically as follows.

[Surfactant]

Surfynol 2502: an ethylene oxide containing acetylene nonionic surfactant manufactured by Air Products Co.

[Water Dispersible Resin]

Vylonal MD1400: polyester emulsion manufactured by Toyobo Co.

TABLE 1

| | | Ink No. | | | | | |
|---|---|---|---|---|---|---|---|
| Component | | 1 | 2 | 3 | 4 | 5 | 6 |
| Colorant | Self-dispersing carbon | 5 | 5 | 5 | 5 | | |
| | black | | | | | | |
| | Self-dispersing copper | | | | | 5 | |
| | phthalocyanine | | | | | | |
| | Copper phthalocyanine | | | | | | 5 |
| | 15:3 (that is pigment | | | | | | |
| | blue 15:3) | | | | | | |
| Water- | Diethylene glycol | 8 | 8 | 16 | 16 | 8 | 8 |
| soluble | Glycerin | 4 | 4 | 8 | 8 | 8 | 8 |
| organic | 1,2-hexanediol | | 8 | 16 | 36 | | |
| solvent | Triethylene glycol | | | | | 4 | 4 |
| | monobutyl ether | | | | | | |

| | | | | | |
|---|---|---|---|---|---|
| Surfactant | 1 | 1 | 4 | 1 | 1 |
| (Surfynol 2502) | | | | | |
| Water dispersible resin | | | | | 20 |
| (Vylonal MD1400) | | | | | |

| | |
|---|---|
| Ion-exchanged water | Remnant |

### Example 2 and Comparative Example 2 (Manufacture of the Recording Medium)

An auxiliary fluid was prepared by mixing each component in a proportion (wt. %) shown in Table 2. This auxiliary fluid was applied to a plain paper (trade name: NM paper, manufactured by Sharp Co.) by a rubber roller of a transfer system so that a coating amount becomes 8 g/m², with result that a recording medium was manufactured.

Among recording mediums a to d, the recording mediums a to c are recording mediums of the example 2 while the recording medium coated with no auxiliary fluid d is a recording medium of the comparative example 2.

TABLE 2

| | | Recording medium No. | | | |
|---|---|---|---|---|---|
| Auxiliary fluid Component | | a | b | c | d |
| Cationic | Polyethylene imine | 8 | | | Coated |
| resin | Polyvinyl pyrrolidone | | 4 | | with no |
| Inorganic | Colloidal silica | | | 12 | auxiliary |
| micro- | | | | | fluid |
| Particles | | | | | |
| Water- | Diethylene glycol | 8 | 8 | | |
| soluble | 1,2-hexanediol | 8 | 8 | | |
| organic | | | | | |
| solvent | | | | | |
| Resin | Vylonal MD1400 | | | 5 | |
| component | | | | | |

| | |
|---|---|
| Ion-exchanged water | Remnant |

### Test Example 1

By using the inks of the example 1 and comparative example 1 and the recording mediums (No. a to d) of the example 2 and comparative example 2, a dynamic contact angle was measured and an image evaluation was conducted in accordance with the following method. The result will be shown in Table. 3.

(1) Dynamic Contact Angle

An initial dynamic contact angle (θ₀) (°) and a variation Δθ/100 msec (°) of a dynamic contact angle were measured under an environment of 25° C. and 60% RH by using a DAT apparatus (manufactured by Fibro Co.). To be specific, droplets (volume: 2 μl) of the inks of the example 1 and comparative example 1 were dripped onto the recording mediums of the example 2 and comparative example 2, and a contact angle θ(°) was measured on every 10 msec for 100 msec after dripping, so that the initial dynamic contact angle (θ₀) at the time of dripping and the variation (Δθ/100 msec) of the contact angle from the dripping to 100 msec were measured.

(2) Image Evaluation

With an ink jet printer (trade name: MC2000, manufactured by Seiko Epson Co.), a high speed printing (6 sheets/min) was carried out by using the ink of the example 1 and the recording mediums of the example 2 and comparative example 1, so that the following evaluation was conducted concerning the obtained recorded image.

(Image Density)

A solid printing was carried out, and its image density was measured by a color checker (trade name: X-Lite 938, manufactured by Macbeth Co.). Evaluations indicated “Very good” for an image density of 1.5 or more, “Good” for an image density of 1.4 or more and less than 1.5, “Not bad” for an image density of 1.3 or more and less than 1.4, and “Poor” for an image density of less than 1.3.

(Blur)

A pattern shown in FIG. 1 was recorded and regarding this pattern, a visual observation by a high-resolution camera (3CCD Color Vision Camera Module XC-003 manufactured by Sony Co.) was carried out under an environment of 25° C. and 60% RH, so that a degree of a line blur (ER) thereof was evaluated based on the following evaluation criteria.

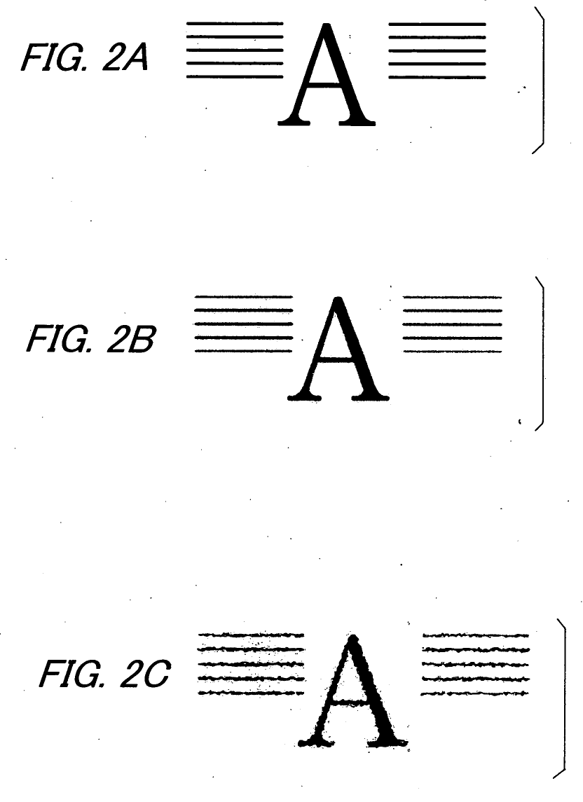

Good: No line blur and very sharp (a state in FIG. 2A).

Not bad: Generated slight line slur and slightly decreased sharpness of a recorded image, but within an allowable range (a state in FIG. 2B).

Poor: Terrible line slur to be a practical problem in use (a state in FIG. 2C)

(Dryness)

Immediately after an end of printing, the plain paper (NM paper) was pushed onto a face on which a recorded image had been formed, for 15 seconds, and evaluations indicated “Good” when an ink of the recorded image was not transferred and “Poor” when the ink thereof was transferred.

TABLE 3

| | | Initial | Variation | | | |
|---|---|---|---|---|---|---|
| | | dynamic | of dynamic | | | |
| | | contact | contact | | | |
| Medium | Ink | angle | angle | Image | | Dry- |
| No. | No. | (θ₀) (°) | Δθ/100 msec(°) | density | Blur | ness |
| a | 1 | 97 | 1 | Very | Good | Poor |
| | | | | good | | |
| a | 2 | 82 | 5 | Very | Good | Good |
| | | | | good | | |
| a | 3 | 71 | 14 | Very | Good | Good |
| | | | | good | | |
| a | 4 | 59 | 19 | Good | Good | Good |
| a | 5 | 80 | 6 | Very | Good | Good |
| | | | | good | | |
| a | 6 | 79 | 6 | Very | Good | Good |
| | | | | good | | |
| b | 1 | 98 | 1 | Very | Good | Poor |
| | | | | good | | |
| b | 2 | 81 | 7 | Good | Good | Good |
| b | 3 | 66 | 11 | Good | Good | Good |
| b | 4 | 56 | 18 | Good | Good | Good |
| b | 5 | 63 | 9 | Good | Good | Good |
| b | 6 | 65 | 8 | Good | Good | Good |
| c | 1 | 86 | 1 | Good | Good | Poor |
| c | 2 | 64 | 10 | Good | Good | Good |
| c | 3 | 57 | 17 | Good | Good | Good |
| c | 4 | 48 | 19 | Not | Good | Good |
| | | | | bad | | |
| c | 5 | 70 | 6 | Good | Good | Good |
| c | 6 | 72 | 7 | Good | Good | Good |
| d | 1 | 96 | 8 | Not | Not | Good |
| | | | | bad | bad | |
| d | 2 | 78 | 22 | Not | Poor | Good |
| | | | | bad | | |
| d | 3 | 63 | 24 | Poor | Poor | Good |
| d | 4 | 48 | 27 | Poor | Not | Good |
| | | | | | bad | |
| d | 5 | 77 | 23 | Poor | Poor | Good |
| d | 6 | 76 | 22 | Poor | Poor | Good |

It is obvious from Table 3 that in a case where a specific configuration of the invention is employed, it is possible to form a sharp image without an ink blur on a plain paper even when a high speed printing is carried out.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, with respect to a recording medium on which a specific ink absorbing property is given by applying an auxiliary fluid containing cationic resin and/or inorganic microparticles, the ink jet recording is carried out by using an ink having an initial dynamic contact angle (θ₀) and a variation of a dynamic contact angle for a duration of 100 msec after contacting the recording medium are within a specific range, whereby generation of a blur, an offset, and the like can be sufficiently prevented regardless of the type of the recording medium even when the recording medium is a plain paper, and it is possible to form a recorded image having an excellent sharpness, high image density, and a prominently favorable image quality. Further, according to the invention, even when a high speed printing is carried out, a to-be-obtained image quality of the recorded image is not be hardly decreased and remains at a very high level.

According to the invention, by using nonionic surfactant and/or water dispersible resin as well as colorant, water-soluble organic solvent, and water, and by adjusting contents thereof, it is made very easy to adjust the initial dynamic contact angle (θ₀) and the variation of the dynamic contact angle to fall within the above-described range.

According to the invention, by using a pigment, preferably a self-dispersing pigment as a colorant in the ink, the generation of the blur, offset, and the like is further prevented, and the sharpness and image density and thus image quality of the to-be-obtained recorded image are further enhanced.

According to the invention, by using polyethylene imine as the cationic resin in the auxiliary fluid, the generation of the blur, offset, and the like is further prevented, and the sharpness and image density and thus image quality of the to-be-obtained recorded image are further enhanced.

According to the invention, provided is an ink jet recording method in which on the recording medium exist an ink having a specific initial dynamic contact angle and a variation of the dynamic contact angle, and an auxiliary fluid containing cationic resin and/or inorganic microparticles, whereby the blur, offset, and the like are not generated regardless of the type of the recording medium even when the recording medium is a plain paper, so that it is possible to form a recorded image having excellent sharpness, high image density, and extremely favorable image quality by a high speed printing.

According to the invention, an ink jet recording sheet is provided in which a recorded image of high quality as described above is formed on a recording medium, especially on a plain paper.

According to the invention, an ink jet apparatus which is suitable for carrying out the above-described ink jet recording method, is provided. By using this apparatus, it is possible to form a recorded image of high quality as described above on the recording medium, especially on the plain paper by a high speed printing.

1. An ink for ink jet recording, which is an ink composition including colorant, water-soluble organic solvent, and water as essential components,
the ink for ink jet recording having an initial dynamic contact angle (θ₀) of 48° or more, and a variation (Δθ/100 msec) of a dynamic contact angle of 2.0° to 20.0°, with respect to a recording medium coated with an auxiliary fluid containing cationic resin and/or inorganic microparticles.

2. The ink for ink jet recording of claim 1, wherein water dispersible resin and/or nonionic surfactant is contained as well as colorant, water-soluble organic solvent, and water.

3. The ink for ink jet recording of claim 1 or 2, wherein the colorant is a pigment.

4. The ink for ink jet recording of claim 3, wherein the pigment is a self-dispersing pigment.

5. The ink for ink jet recording of any one of claims 1 to 4, wherein the cationic resin contained in the auxiliary fluid is a polyethylene imine.

6. An ink jet recording method for carrying out recording by attaching an ink composition onto a recording medium, comprising:
attaching an auxiliary fluid containing cationic resin and/or inorganic microparticles as well as the ink for ink jet recording of any one of claims 1 to 5 onto the recording medium.

7. A recording sheet that is a recording medium on which a recorded image is formed by the jet recording method of claim 6.

8. An ink jet recording apparatus comprising:
recording medium supplying means for supplying a recording medium;
recording medium conveying means for conveying the recording medium supplied by the recording medium supplying means;
printing means for carrying out recording by attaching the ink for ink jet recording of any one of claims 1 to 4 to the recording medium conveyed by the recording medium conveying means;
discharging means for discharging the recording medium on which a recorded image has been formed by the printing means; and
auxiliary fluid transfer means for attaching an auxiliary fluid containing cationic resin and/or inorganic microparticles to the recording medium.

9. The ink jet recording apparatus of claim 8, wherein the auxiliary fluid transfer means is provided so as to be included in the recording medium conveying means, or between the recording medium conveying means and the printing means.
